(19) United States
(12) Patent Application Publication
(10) Pub. No.: US 2006/0192916 A1
(43) Pub. Date: Aug. 31, 2006

(54) Rimless eyewear system with magnetic retention

(75) Inventors: Philip J. Langley, Plano, TX (US); Greg Smith, Plano, TX (US)

Correspondence Address: STORM L.L.P., BANK OF AMERICA PLAZA, 901 MAIN STREET, SUITE 7100, DALLAS, TX, 75202, US

(73) Assignee: E'lite Optik, Inc., Carrollton, TX (US)

(21) Appl. No.: 11/363,312

(22) Filed: Feb. 27, 2006

Related U.S. Application Data
(60) Provisional application No. 60/656,614, filed on Feb. 25, 2005.

(51) Int. Cl. G02C 5/00

(52) U.S. Cl. 351/41

(57) ABSTRACT

Primary and auxiliary lens assemblies are provided that allow a wearer easy usage with a reduced risk of misalignment or detachment through the use of micromagnets. Conventional magnetic auxiliary lens assemblies are typically not compatible with frameless or rimless designs. The improved assemblies disclosed herein employ magnets embedded in either or both of the auxiliary lens assemblies and the bushings of the primary lens assemblies.

### TECHNICAL FIELD OF INVENTION

The present invention relates to eyewear, and in particular, to an eyewear assembly that incorporates an auxiliary lens assembly for removable attachment to a primary lens assembly. Still more specifically, the present invention relates to an auxiliary lens assembly configured for magnetic attachment to a rimless primary lens assembly.

### BACKGROUND OF THE INVENTION

It has long been desirable to have a removable auxiliary lens assembly attached to eyeglasses. Professional baseball players have used “flip-up” auxiliary lenses for more than four decades to protect their eyes from the sun, but to allow them unrestricted vision in the event the ball was hit in their vicinity.

U.S. Pat. No. 3,252,747 to Robins (“Robins”) discloses an eyewear system specifically designed for persons who are farsighted. The device includes an assembly in which an auxiliary frame assembly containing lenses may be rotated about the horizontal axis and remain attached to a primary assembly so as to position the lenses the proper distance to the eyes every time the device is lowered into place. A significant disadvantage of this design is that it is unattractive, overly complicated, impossible to segregate from the primary frame, and does not permit or accommodate anyone other than farsighted individuals.

U.S. Pat. No. 6,089,708 to Ku (“Ku”) discloses a connecting member having spaced connecting plates for attachment to the bridge portion of a primary lens assembly. The connecting plates have magnetic members that act cooperatively with a complimentary magnetic member inserted in a hole on the bridge. The front of the connecting part has an open communication to a polygonal shaped holding room. The auxiliary frame has connecting rods extending above the bridge portion, and supporting an intermediate portion having a polygonal shape, receivable and rotatable in the holding room. A significant disadvantage of this design is that it is unattractive, overly complicated, and resists easy and immediate removal of the auxiliary lens assembly.

U.S. Pat. No. 3,238,005 to Petitto (“Petitto”) discloses the combination of a primary lens assembly and auxiliary lens assembly. The auxiliary assembly has flexible sidewall projections with openings that can be assembled onto lugs (pins) extending perpendicularly from the sides of the primary assembly, allowing the auxiliary assembly to be pivoted upwards, and back downwards. Leaf springs mounted on the auxiliary assembly engage surfaces of the primary assembly to urge the auxiliary assembly into position. A significant disadvantage of this design is that it is unattractive, overly complicated, and resists easy and immediate removal of the auxiliary lens assembly.

As stated, these and other mechanically clipped-on devices for holding auxiliary lenses are cumbersome and unattractive, particularly for frameless or rimless designs. More recently, numerous attempts have been made to magnetically attach an auxiliary lens assembly to a primary lens assembly.

U.S. Pat. No. 4,070,103 to Meeker (“Meeker”), in one embodiment, discloses a primary lens assembly having a slidably attachable auxiliary lens assembly. In this device, the primary lens assembly is made of magnetizable material and auxiliary lenses are individually securable to the primary lens assembly by a magnetic band inserted in a groove on the inside surface of the individual auxiliary lens assembly. This design is not pivotal, and the auxiliary assembly must be physically removed.

U.S. Pat. No. 5,416,537 to Sadler (“Sadler”) discloses a primary lens assembly having a first magnetic member attached vertically to the front surface of the primary lens assembly, and a second magnetic member attached in a corresponding position on the back surface of an auxiliary lens assembly. The magnetic members are arranged for engagement to secure the auxiliary lens assembly to the primary lens assembly. This design is not pivotal, and the auxiliary assembly must be physically removed.

U.S. Pat. No. 5,568,207 to Chao (“Chao”), in one embodiment, also discloses a magnetically adhered auxiliary lens assembly, with the additional feature of arms extending from the side portions of the auxiliary lens assembly, over magnet retaining projections and extensions of the primary lens assembly. The arms engage with, and are supported on, the primary lens assembly extensions to prevent disengagement of the auxiliary lens assembly upon downward movement of the auxiliary lens assembly relative to the primary lens assembly. This design is not pivotal, and the auxiliary assembly must be physically removed.

Many of the recent developments in auxiliary eyewear systems, such as those described above, rely on a combination of mechanical and magnetic engagement. The magnetic engagements themselves are insufficiently strong to retain the auxiliary frame assembly. Additionally, the auxiliary frame assembly must be removed from the primary frame assembly, and handled and stored separately when it is necessary for the eyeglass wearer to look only through the lenses of the primary frame assembly. They do not have the advantages of the early flip-up designs, which permitted quick movement of the auxiliary assembly out of alignment with the primary assembly without separating it from the primary assembly.

U.S. Pat. No. 6,474,811 to Liu (“Liu”) discloses a magnetically attached auxiliary lens assembly in which the auxiliary assembly can be magnetically attached to either the inside or outside of extensions having magnets on the primary assembly. The auxiliary assembly is pivotal upwards, removing the pivotal alignment of the auxiliary and primary lenses. A significant disadvantage of this design is that it is unstable, relying on tenuous repositioning and magnetic forces alone to align and support the auxiliary assembly to the primary assembly. Another significant disadvantage of this design is that it causes the auxiliary frame to be positioned into the forehead of the wearer, making raising the auxiliary assembly fully perpendicular to the primary assembly impractical.

U.S. Pat. No. 6,601,953 to Xiao (“Xiao”) discloses an auxiliary lens assembly having pivots mounted above the lenses and attached by long, L-shaped shelter arms. The shelter arms are attached to supporting arms having magnet holding housings attached at their ends. Magnets are inset in the housings for engagement over rearwardly protruding rim lockers. One disadvantage of this design is that it fails to limit the rotation of the auxiliary lens assembly. Another disadvantage is that it is aesthetically unappealing, due in part to the long shelter arm requirement. Another disadvantage is that it relies on a bridge magnet or bride hook for stability. Another disadvantage is that the device relies on magnetic force to pull the magnetic housing forward, over a rearward protruding lens locker, requiring the user to push the auxiliary frame awkwardly rearward, into the primary frame, to disengage the magnetic housing from over the lens locker. Another disadvantage is that the device is complex and expensive to manufacture.

Each of these designs require a lens that is limited in width, so as to accommodate the magnets and mechanical engaging apparatus on the outside of the lenses. As a result, peripheral vision through the lens is limited. This can give rise to both convenience and safety issues. For example, a nearsighted person trying to change lanes on a freeway is forced to rotate his/her head significantly further around to allow alignment of the eyes through the lenses in the direction of the vehicle's blind spot. These processes increase the time required to effect the maneuver, and require an increased time in which the direction in which the car is traveling at high speed is not visible. Problems occur again when trying to back up a vehicle.

The prior art magnets and mechanical engaging apparatus on the outside of the lenses used to attach the auxiliary lens assembly to the primary lens assembly typically involve extensions on the primary frames. The extensions must be large enough to accommodate magnets that are large enough to exert the necessary force to retain the auxiliary lenses in place. Similarly, the prior art auxiliary lens assembly will require extensions that, in one manner or another, protrude over the extensions of the primary frame assembly, and include retainers for supporting auxiliary magnets.

The resulting disadvantage is that the prior art designs for primary and auxiliary lens assemblies involve delicate soldering of numerous extraneous parts which extend from the sides of the lens assemblies. The only purpose of the several extraneous parts is to support the magnets and/or mechanical engagement of the auxiliary frame assembly to the primary frame assembly.

Meeker, in a second embodiment, discloses eyeglasses having attachable pairs of lens rim covers. The lens rims are made of magnetizable material. A magnetic strip is provided in a groove on the inside surface of the lens cover. When the lens rim cover is placed on the rim, it is magnetically supported. A disadvantage of this invention is that the magnetic band made of conventional magnet materials is bulky and heavy, and the entire assembly is overly complicated. Also, band-like magnetic materials must be ductile enough to prevent breakage, and thus the compositions of the magnetic materials suitable for use are limited.

Chao, in a second embodiment, discloses a spectacle, or eyeglass, frame including a primary frame and a secondary frame having one or more magnetizable members embedded within the eyeglass frame prior to magnetizing the members. The magnetizable members are then electroplated, painted, and magnetized with a magnetizing machine, such as an electromagnetic machine. A disadvantage of this design is that the resulting eyeglass frame is relatively bulky and the discrete magnets made of conventional materials lack sufficient power and life to support the auxiliary lens assembly to the primary lens assembly.

U.S. Pat. No. 6,412,942 to McKenna and Smith (“McKenna”) discloses one embodiment where a heat-treated magnetic alloy auxiliary frame assembly configured to magnetically couple the auxiliary lens assembly to the primary lens assembly is employed. Heat treating of a spinodal decomposition alloy magnetizes the alloy, and therefore, the auxiliary frame is formed entirely from a magnetic alloy. The disadvantage of this design is in the manufacture cost and challenges associated with heat treating a thin metal frame, as well as the lack of strength and life of the magnetic field.

McKenna, in another embodiment, discloses an auxiliary frame that is at least formed from a magnetic alloy, wherein the alloy is uniformly distributed throughout the auxiliary frame. Specifically, McKenna emphasizes uniformity of magnetic material throughout the auxiliary lens as an advantage over the use of discrete components. However, there are disadvantages associated with employing uniformly distributed magnetic materials throughout the auxiliary lens assembly. In particular, the cost of metallurgy associated with the manufacture of uniformly distributing magnetic materials can be high.

U.S. Pat. No. 6,331,057 to Strube (“Strube”) discloses a clip-on option for the auxiliary lens assembly in which the auxiliary lens assembly is held by small but powerful cylindrical magnets made of zinc-coated neodymium, located in the auxiliary bridge region and the primary bridge region. The magnetic material is disclosed as preferred for its superior remanence and coercivity. Neodymium magnets are the magnets most commonly used in the eyewear industry.

In each of the prior art designs, a complete frame is required. Therefore, for a person to utilize an auxiliary frame with rimless or frameless designs, mechanical couplings are required. To date, there has not been a magnetic assembly that is compatible with frameless or rimless designs.

It can thus be seen that there is a need to develop a design for a combined lens assembly which is attachable without the numerous extraneous parts and soldered assemblies of traditional designs, which encumber their appearance and limit the lens width, especially with frameless or rimless designs. There is also a need to simplify the structure and assembly of primary lens assemblies. There is also a need to provide a magnetically attached auxiliary lens assembly that is lightweight. There is also a need to provide an auxiliary lens assembly that is easily attachable to the primary frame assembly, without the need to maneuver complex mechanical components into alignment and engagement.

### SUMMARY OF THE INVENTION

The auxiliary lens assembly may be attached to the primary lens assembly. In this manner, the person wearing the eyewear system has two lenses combining to alter the transmission of light to each eye.

In a preferred embodiment, the primary lenses are corrective lenses and the auxiliary lenses are light transmission reducing lenses, for example, polarizing, absorbing, refracting, photochromatic, or reflecting lenses, or any combination thereof (i.e., sunglasses). In another preferred embodiment, the primary lenses are impact resistant safety lenses and the auxiliary lenses are light transmission reducing lenses, such as welding lenses. In another preferred embodiment, the primary lenses are corrective lenses and the auxiliary lenses are corrective lenses. In another preferred embodiment, the primary lenses are corrective lenses and the auxiliary lenses are impact resistant safety lenses.

In one preferred embodiment of the present invention, a frameless eyewear system is provided. Within the system, there is a primary lens assembly and an auxiliary lens assembly. The primary lens assembly has a pair of primary lenses held in a fixed position relative to one another by a primary bridge. Additionally, a pair of arms are secured to each of the primary lenses through at least one hole in each of the primary lenses. To secure the arms in place, a pair of bushings are provided that are coupled to the arms through the holes in the primary lenses. Unique to this invention, the bushings have magnetic attachment assemblies.

An auxiliary lens assembly is provided to couple to the primary lens assembly. The auxiliary lens assembly employs a pair of lenses held in fixed position relative to one another by an auxiliary bridge. A pair of auxiliary extensions are attached to the auxiliary lenses. Each auxiliary extension has an auxiliary magnetic attachment assembly for engaging the primary magnetic attachment assembly.

In the preferred embodiment of the present invention, the primary magnetic attachment assembly further comprises a subsurface mounted magnet. In this embodiment, the primary magnetic attachment assembly further comprises a slot with a magnet secured therein.

In another preferred embodiment, the magnets are micromagnets. In another embodiment of the present invention, the micromagnet is formed of a Rare-Earth 2 Transition Element having a Maximum Energy Product of at least 210 kJ/m3.

In another embodiment, the micromagnet is formed of a material selected from the group consisting of Rare Earth Cobalt 5 alloys and Rare Earth Iron alloys.

In another embodiment, the micromagnet is formed of an International Electrotechnical Commission (IEC) Code Reference R4-1 material.

In another embodiment, the micromagnet is formed of an alloy comprising between 22 and 29 percent by weight samarium.

In another embodiment, the micromagnets are less than approximately 0.55 millimeters in height, less than approximately 0.55 millimeters in width, and at least 1.2 millimeters in length. In a further embodiment of the present invention, the micromagnets are approximately 0.45 millimeters in height, approximately 0.45 millimeters in width, and approximately 2 millimeters in length.

In yet another embodiment of the present invention, at least two micromagnets are located in the slot. In another embodiment, at least two micromagnets are located within each bushing.

A primary advantage of the disclosed embodiments of the present invention is that it permits magnetic attachment with rimless eyewear. Another advantage is that it allows utilization of wider lenses to improve peripheral vision. Another advantage is that it does not require large, complex, or heavy mechanical interlocking engagements to prevent disassociation of the auxiliary lens assembly from the primary lens assembly.

Another advantage of the disclosed embodiments of the present invention is that it is less expensive to manufacture. Another advantage is that it provides a simplified and easy alignment between the auxiliary lens assembly and the primary lens assembly. Another advantage is that it provides a magnetic system that does not require electroplating or other coating. Other advantages is that it provides an eyewear system that is aesthetically appealing and lightweight.

The foregoing has outlined rather broadly the features and technical advantages of the disclosed embodiments of the present invention in order that the detailed description of the invention that follows may be better understood. Additional features and advantages of the invention will be described hereinafter which form the subject of the claims of the invention. It should be appreciated by those skilled in the art that the conception and the specific embodiments disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

The objects and features of the invention will become more readily understood from the following detailed description and appended claims when read in conjunction with the accompanying drawings in which like numerals represent like elements.

The drawings constitute a part of this specification and include exemplary embodiments to the invention, which may be embodied in various forms. It is to be understood that in some instances various aspects of the invention may be shown exaggerated or enlarged to facilitate an understanding of the invention.

FIG. 1 is an isometric view of an auxiliary lens assembly and a primary lens assembly in accordance with a preferred embodiment of the present invention.

FIG. 2 is a front break-out view illustrating the auxiliary lens assembly of FIG. 1.

FIG. 3 is a rear break-out view illustrating the primary lens assembly of FIG. 1.

FIG. 4 is a side view of the auxiliary lens assembly of FIG. 1 attached to the primary lens assembly of FIG. 1 in accordance with that embodiment.

FIG. 5 is a top view of an arm of the primary lens assembly in accordance with a preferred embodiment of the present invention.

FIG. 6 is a top view of a bushing having a magnet embedded at the rear surface of the bushing, in accordance with a preferred embodiment of the present invention.

FIG. 7 is a top view of a bushing having a magnet fully embedded within the bushing in accordance with another preferred embodiment of the present invention.

FIG. 8 is a top view of a levered arm of a primary lens assembly having a hinged portion, in accordance with another preferred embodiment of the present invention.

FIG. 9 is a top view of an arm having an alternative pin configuration in accordance with another preferred embodiment of the present invention.

FIG. 10 is a top view of an alternative bushing configuration for complementary connection to the pin configuration illustrated in FIG. 9.

FIG. 11 is a side view of an alternative configuration of an auxiliary lens assembly attachment to a primary lens assembly in accordance with another preferred embodiment of the present invention.

FIG. 12 is a top view of an alternative bushing configuration having a magnet embedded at the top surface of the bushing in accordance with a preferred embodiment of the present invention.

FIG. 13 is a rear break-out view of a primary lens assembly utilizing the bushing configuration of FIG. 12.

FIG. 14 is a rear break-out view of an auxiliary lens assembly configured to couple with the embodiment illustrated in FIG. 13.

FIG. 15 is a rear break-out view illustrating the auxiliary lens assembly of FIG. 14 attached to the primary lens assembly of FIG. 13.

FIG. 16 is a rear break-out, cross-sectional view of the combined embodiments illustrated in FIGS. 13 and 14.

### DETAILED DESCRIPTION OF THE PREFERRED EMBODIMENTS

In the following discussion, numerous specific details are set forth to provide a thorough understanding of the present invention. However, those skilled in the art will appreciate that the present invention may be practiced without such specific details. In other instances, well-known elements have been illustrated in schematic or block diagram form in order not to obscure the present invention in unnecessary detail.

The following description is presented to enable any person skilled in the art to make and use the invention, and is provided in the context of a particular application and its requirements. Various modifications to the disclosed embodiments will be readily apparent to those skilled in the art, and the general principles defined herein may be applied to other embodiments and applications without departing from the spirit and scope of the present invention. Thus, the present invention is not intended to be limited to the embodiments shown, but is to be accorded the widest scope consistent with the principles and features disclosed herein.

Positional terms such as “right” and “left”, “front” and “back”, and “top” and “bottom,” as may be used herein are referenced from the perspective of a person wearing the primary and auxiliary lens assemblies. The references are intended to aide in the description of the device, and are not intended to be limiting, since the preferred embodiments of the device are generally symmetric.

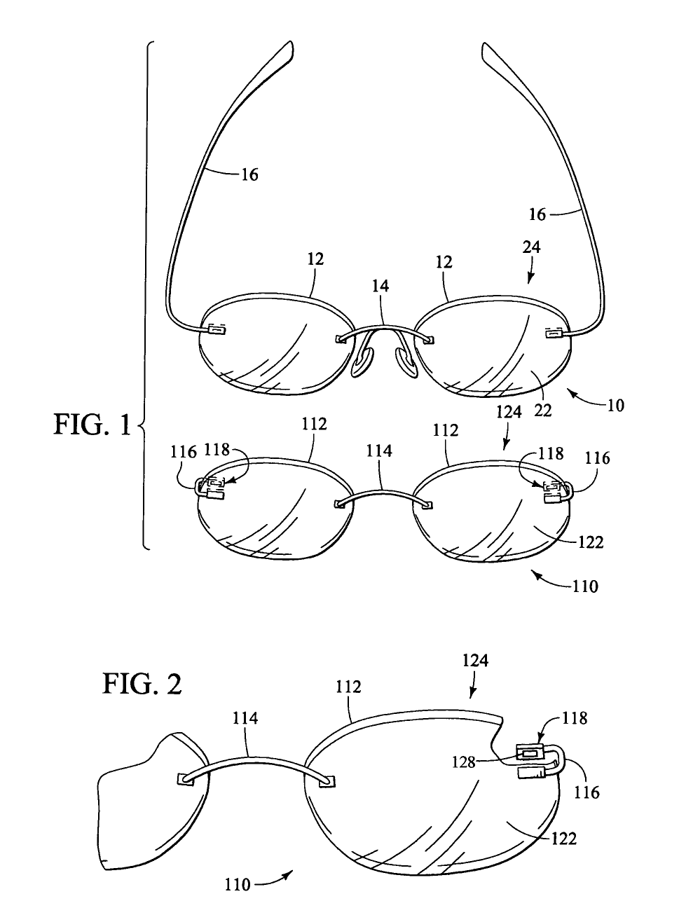

FIG. 1 is an isometric view of a preferred embodiment of the present invention. In this view, a primary lens assembly 10 is illustrated with an auxiliary lens assembly 110 detached from primary lens assembly 10.

As can be seen in FIG. 1, primary lens assembly 10 comprises a pair of primary lenses 12. Primary lenses 12 each have a front 22 and a back 24. Primary lenses 12 also have holes (not shown) extending therethrough from front 22 to back 24.

Primary lens assembly 10 further comprises a primary bridge 14 to hold primary lenses 12 in a fixed position relative to one another. In the illustrated embodiment, primary bridge 14 is secured directly to primary lenses 12 without the use of a frame or rims wholly or partially encircling primary lenses 12.

Additionally, primary lens assembly 10 includes a pair of arms 16. Arms 16 are attached, one each, to the outer periphery of primary lenses 12. Arms 16 are secured in holes (not shown) through primary lenses 12. When in use, arms 16 can rest in a position over the ears of the wearer. Additionally, when worn, back 24 of primary lens assembly 10 is proximate to the face of the wearer.

Still referring to FIG. 1, auxiliary lens assembly 110 is also illustrated. Auxiliary lens assembly 110 has a pair of auxiliary lenses 112. Auxiliary lenses 112 each have a front 122 and a back 124. Back 124 of auxiliary lens assembly 110 is proximate to the face of the wearer. Front 122 faces away from the wearer. Auxiliary lenses 112 also have holes (not shown) that may extend from front 122 to back 124.

Auxiliary lens assembly 110 further comprises an auxiliary bridge 114 to hold auxiliary lenses 112 in a fixed position relative to one another. In the illustrated embodiment, auxiliary bridge 114 is secured directly to auxiliary lenses 112 without the use of a frame or rims wholly or partially encircling auxiliary lenses 112.

Auxiliary lens assembly 110 further comprises auxiliary extensions 116. As can best be seen in FIG. 2, auxiliary extensions 116 are attached to auxiliary lens assembly 110 through holes (not shown) in auxiliary lenses 112.

Each of auxiliary extensions 116 further comprises an auxiliary magnetic assembly 118. Auxiliary magnetic assembly 118 is formed at one end of auxiliary extensions 116. In the preferred embodiment, auxiliary magnetic assembly 118 includes a magnet 128 embedded therein. In another embodiment, auxiliary magnetic assembly 118 employs a magnetically attractable material.

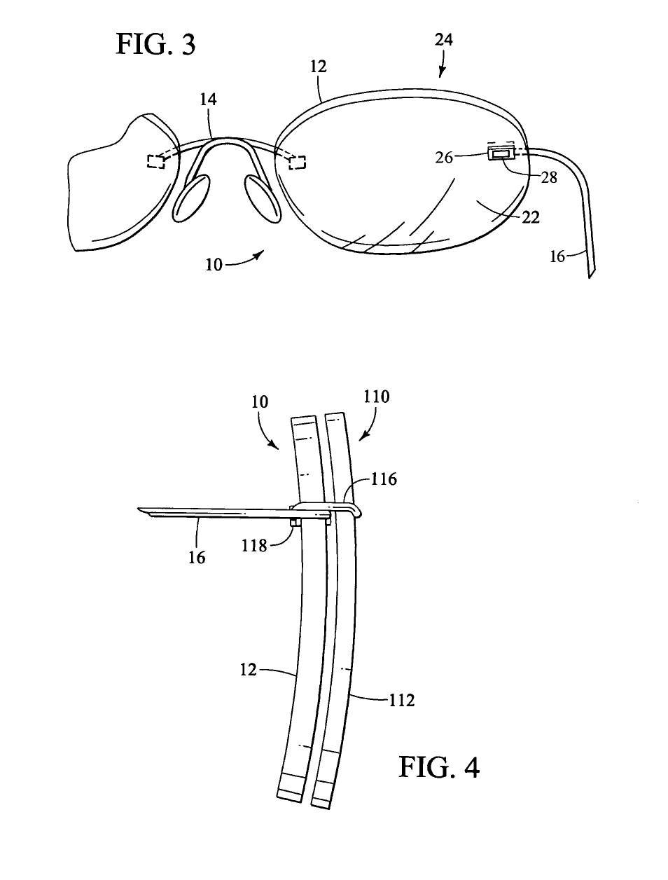

FIG. 3 illustrates a rear view of primary lens assembly 10 in accordance with a preferred embodiment of the present invention. As can be seen in FIG. 3, primary lens assembly 10 further comprises a bushing 26. Bushing 26 is located on back 24 of primary lens assembly 10. A magnet 28 is embedded in bushing 26. In another embodiment, magnet 28 is replaced with a magnetically attractable material.

In another preferred embodiment, magnets 28 and/or magnets 128 are micromagnets. Typically, micromagnets are magnets that are too small to be pressed into individual magnets. Instead, micromagnets are pressed into blocks that are larger than the final desired size. The larger blocks are then magnetized and sectioned to the desired size. Micromagnets that have consistent magnetic properties generally have a cross-section that is less than approximately 4 mm by 4 mm, and a length which dimension is longer than the cross-sectional dimensions, and which defines the direction of magnetization.

In a more preferred embodiment, magnets 28 and/or 128 are micromagnets made of a Rare-Earth 2 Transition Element having a Maximum Energy Product of at least 210 kJ/m3. In a still more preferred embodiment, the micromagnets are made of an alloy comprising between 22 and 29 percent by weight samarium. Other alloys can also be employed, such as those magnets formed of Rare Earth Cobalt 5 alloys, Rare Earth Iron alloys, and International Electrotechnical Commission (IEC) Code Reference R4-1 materials.

FIG. 4 is a side view of auxiliary lens assembly 110 attached to primary lens assembly 10. When primary lens assembly 10 and auxiliary lens assembly 110 are coupled, primary lenses 12 and auxiliary lenses 112 are in substantial alignment. In the preferred embodiment illustrated, arm 16 mechanically supports auxiliary extension 116, and auxiliary magnetic assembly 118 is magnetically coupled to magnet 28 of bushing 26.

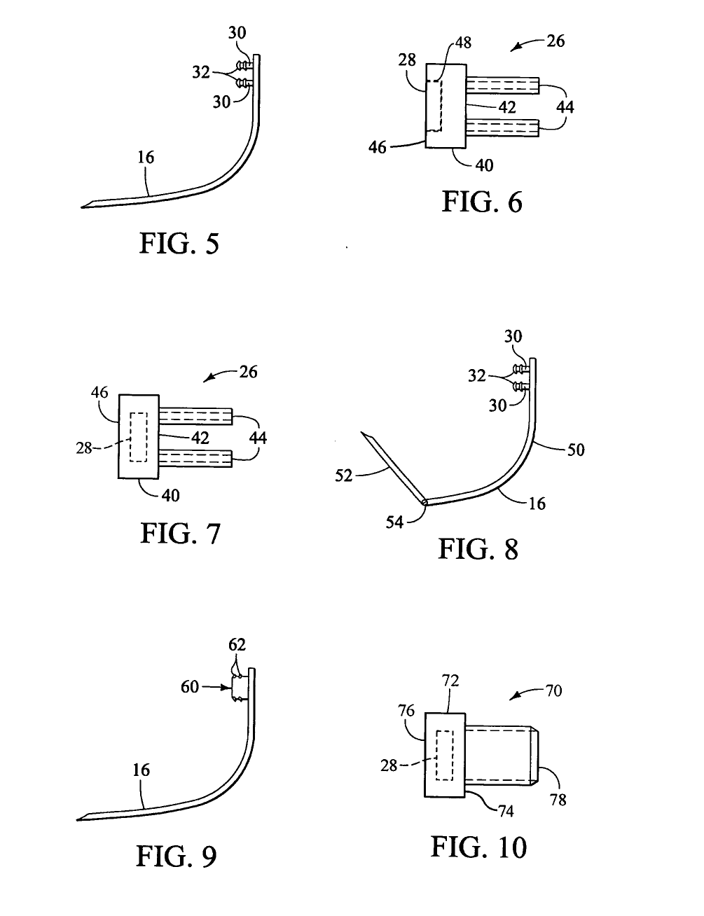

FIG. 5 is a top view of one of arms 16 in accordance with a preferred embodiment of the present invention. Arms 16 are each typically a curved metal bar. At least one pin 30 is located at the end of each arm 16. In the preferred embodiment shown, two pins 30 are located at an end of each arm 16. At least one barb 32 is located on each of pins 30. In the preferred embodiment shown, two barbs 32 are located on each pin 30.

FIG. 6 illustrates a top view of bushing 26. Bushing 26 comprises a body 40 having a front surface 42 and a rear surface 46. One or more receptacles 44 protrude from front surface 42. Receptacles 44 are hollow and receivable of pins 30 in an interference fit with barbs 32. A slot 48 is provided proximate to rear surface 46. One or more magnets 28 are mounted in slot 48. Adhesives are commercially available and well known in the art for attaching magnets to plastic or metal surfaces, such as those commonly used in the eyewear industry. The same adhesives are applicable for use to secure micromagnets 28 within slot 48.

As can be seen in FIGS. 1 and 2, when arms 16 are connected to primary lens assembly 10, pins 30 protrude through the holes (not shown) in primary lenses 12. Bushings 26 are also located in the holes in primary lenses 12. Pins 30 are coupled to bushings 26 through the hollow centers of receptacles 44. In this configuration, barbs 32 of pins 30 securely engage the hollow centers of receptacles 44, securing arms 16 to front 22 of primary lenses 12, and securing bushings 26 to back 24 of primary lenses 12.

In a more preferred embodiment illustrated in FIG. 7, magnet 28 is fully embedded within body 40 of bushing 26. In this embodiment, bushings 26 may be formed over micromagnets 28.

FIG. 8 discloses an alternative embodiment of arms 16, depicted in a top view. Each of arms 16 in this preferred embodiment comprises a primary extension 50. Primary extension 50 has an end that terminates near front 22 of primary lens 12. Primary extension 50 has one or more pins 30. Pins 30 have barbs 32. Each of arms 16 further comprises a levered arm 52 and a pivot 54. Primary extension 50 couples to lever arm 52 at a pivot 54.

FIG. 9 discloses a top view of yet another preferred embodiment of the present invention in which arms 16 employ a single pin 60. Barbs 62 are located on pin 60.

FIG. 10 discloses a bushing for complementary connectivity with pin 60 of FIG. 9. In this embodiment, bushing 70 comprises a body 72 having a front surface 74 and a rear surface 76. A hollow receptacle 78 protrudes from front surface 74. Magnet 28 is located in slot 48, or more preferably, fully embedded in body 72. In this embodiment, the exterior of receptacle 78 is preferably non-cylindrical.

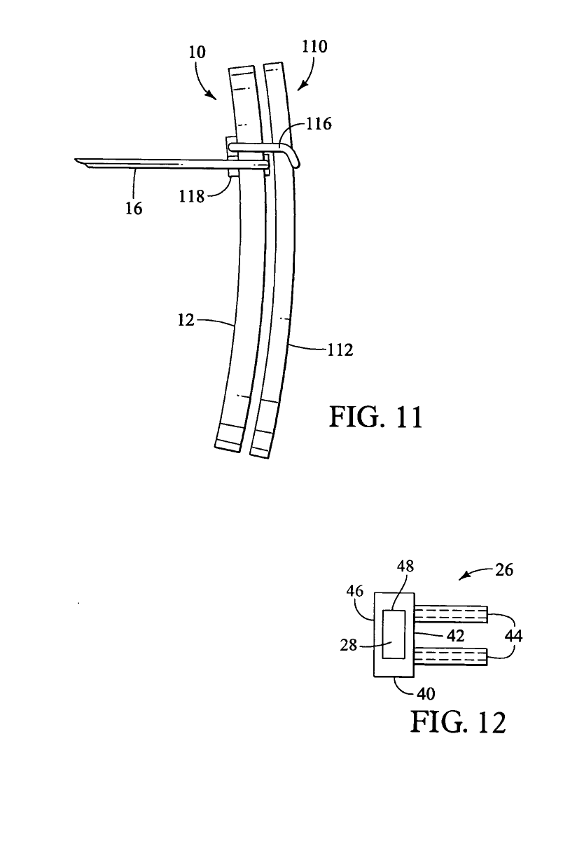

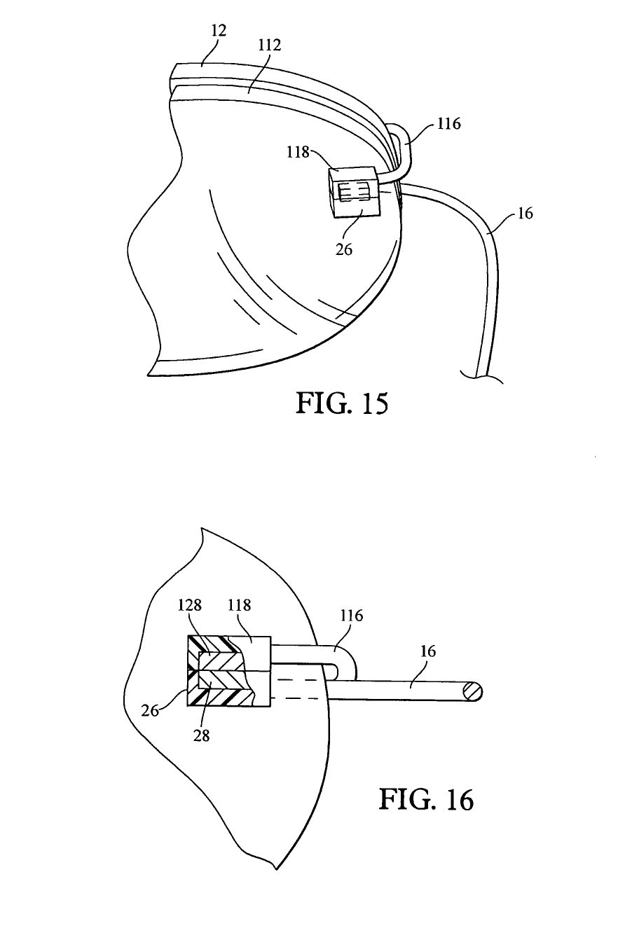

FIGS. 11 through 16 disclose an alternative embodiment of the attachment of auxiliary lens assembly 110 to primary lens assembly 10. In this preferred embodiment, as best seen in FIGS. 11, 15, and 16, auxiliary magnetic assembly 118 rests in a position above bushing 26. A gap is provided between arm 16 and auxiliary extension 116 to prevent rubbing of externally visible surfaces. Thus, magnetic coupling forces and mechanical support forces maintain the position of auxiliary lens assembly 110 relative to primary lens assembly 10.

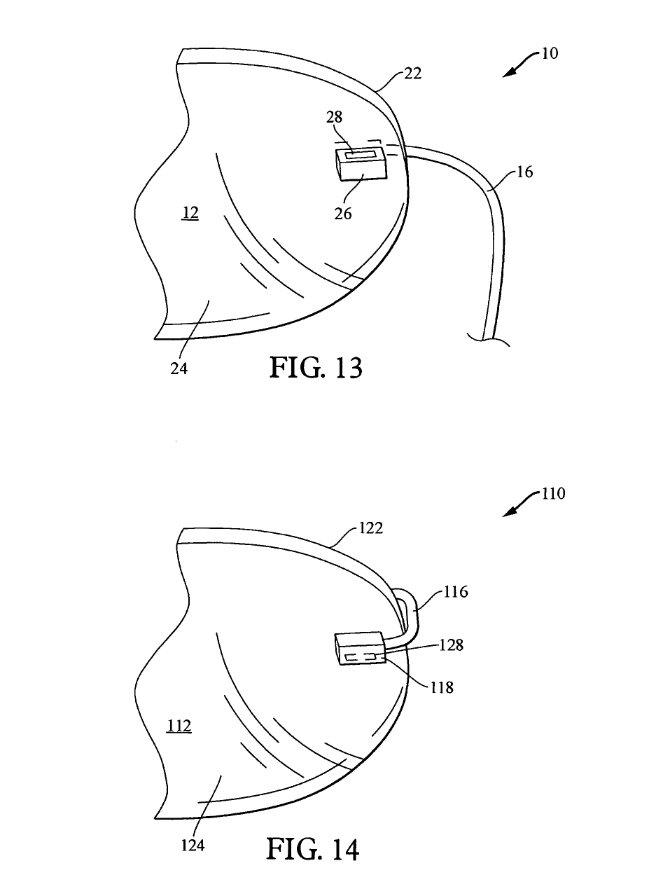

Referring to FIG. 12, a top view of bushing 26 having a magnet 28 in accordance with another preferred embodiment of the present invention is shown. In this embodiment, slot 48 is located on the top of body 40, between front 42 and back 46. Magnet 28 is located in slot 48. Thus, as can best be seen in FIG. 13, bushing 26 can be oriented in a position where magnet 28 faces upward so as to couple to auxiliary magnetic assembly 118 as illustrated in FIG. 14.

FIG. 16 is a rear break-out, cross-sectional view illustrating the embodiments of FIGS. 13 and 14 attached together. It should be understood and appreciated that any combination of the particular mounting of magnets 28 illustrated in FIGS. 6, 7, and 12, can be combined with any configuration of magnetic assembly 118, and still provide the desired functionality of the invention.

In another embodiment, multiple micromagnets 28 are located in a single slot 48 or embedded together within bushing 26. Moreover, any combination of micromagnets 28 used singularly, or in combination, can be employed in any embodiment described hereinabove.

### OPERATION OF THE PREFERRED EMBODIMENTS

The various embodiments disclosed herein which include magnetic attraction will be appreciated by one of ordinary skill in the art to involve a combination of magnet-to-magnet magnetic engagement, or magnet-to-magnetic material magnetic engagement. “Magnetic material” as used herein is defined as materials subject to attraction by magnetic force, or magnetically attractable.

Referring to FIG. 1 of the drawings, an isometric view of a preferred embodiment of the present invention is depicted. Accordingly, a primary lens assembly 10 and an auxiliary lens assembly 110 are depicted.

Primary lens assembly 10 is commonly referred to as a “frameless” or “rimless” pair of glasses. With a frameless pair of glasses, there is no perimeter surrounding support for primary lenses 12. In a preferred embodiment, holes are drilled into each of primary lenses 12, and support structures are attached thereto. Primary bridge 14 is located between two primary lenses 12 and coupled to each of primary lenses 12. Primary bridge 14 thus maintains primary lenses 12 in a fixed position relative to one another.

Along the outside of primary lens assembly 10, arms 16 are coupled to primary lenses 12 through holes in each primary lens 12. Arms 16 curl or bend around the edge of its respective primary lens 12 and protrudes back in the direction of the face of the wearer in order to rest over the ears of the wearer.

Auxiliary lens assembly 110 also employs a frameless design. Accordingly, auxiliary lenses 112 are held in a fixed position relative to one another by auxiliary bridge 114.

Auxiliary extensions 116 curl or bend around the edge of auxiliary lenses 112 and protrude in a direction of the face of the wearer. As can best be seen in FIG. 2, extensions 116 employ an auxiliary magnetic assembly 118. In the preferred embodiment, auxiliary magnetic assembly 118 includes magnets 128. Magnets 128 can either be attached to the surface of auxiliary magnetic assembly 118 or, more preferably, embedded in a slot therein.

Referring to FIG. 3, a front view of primary lens assembly 10 is depicted in accordance with a preferred embodiment of the present invention. As can be seen in FIG. 3, a bushing 26 is located on back 24 of primary lens assembly 10. Bushing 26 couples with arm 16 through holes in primary lens 12 in order to secure arm 16 in a fixed position. Magnet 28 is attached or embedded in bushing 26. In an alternative embodiment, either bushing 26 or magnetic assembly 118 has no magnet, but is made of a magnetically attractable material.

In another preferred embodiment, magnets 28 and/or magnets 128 comprise one or more micromagnets. Typically, micromagnets are magnets that are too small to be pressed into individual magnets. Instead, micromagnets are pressed into blocks that are larger than the final desired size. The larger blocks are then magnetized and sectioned to the desired size. Micromagnets that have consistent magnetic properties generally have a cross-section that is less than approximately 4 mm by 4 mm, and a length which dimension is longer than the cross-sectional dimensions, and which defines the direction of magnetization.

In a more preferred embodiment, magnets 28 and/or 128 are micromagnets made of a Rare-Earth 2 Transition Element having a Maximum Energy Product of at least 210 kJ/m3. In a still more preferred embodiment, the micromagnets are made of an alloy comprising between 22 and 29 percent by weight samarium. Other alloys can also be employed, such as those magnets formed of Rare Earth Cobalt 5 alloys, Rare Earth Iron alloys, and International Electrotechnical Commission (IEC) Code Reference R4-1 materials.

The micromagnets thus specified have the benefit of resistance to oxidation without the need for plating. Because of their small size, plating of micromagnets can cause geometric inconsistencies that negatively affect their ability to be located in slots 48 having complementary geometries to magnets 28.

As can best be seen in FIG. 4, a side view of auxiliary lens assembly 110 attached to primary lens assembly 10 is depicted. When primary lens assembly 10 and auxiliary lens assembly 110 are combined, auxiliary lenses 112 and primary lenses 12 are in substantial alignment to create the desired visual affect. Extension 116 rests on arm 16 providing a mechanical resistance to undesired separation of auxiliary lens assembly 110 from primary lens assembly 10, and permitting auxiliary magnetic assembly 118 to couple with magnet 28 of bushing 26.

As seen if FIG. 5, near the end of arm 16 that terminates proximate to primary lens 12, supports are employed to secure the position of arm 16. One or more pins 30 protrude from arm 16 in a direction of the face of the wearer. Pins 30 can have a variety of curvilinear or other shapes including, but not limited to, cylindrical shapes.

Mechanical coupling of arm 16 to bushing 26 is provided by interference fit of barbs 32 in receptacles 44. Barbs 32 act to prevent disengagement of arm 16 from bushing 26. When bushing 26 mechanically engages pins 30, front surface 42 of bushing 26 is substantially flush with back 24 of primary lens assembly 10.

As best seen in FIG. 6, magnet 28 is mounted in slot 48 substantially flush with rear surface 46 of body 40. Magnet 28 may alternatively be one or more micromagnets. Adhesives are commercially available and well known in the art for attaching magnets to eyewear. The same adhesives are applicable for use with magnets 28.

In another preferred embodiment of the present invention, as depicted in FIG. 7, magnet 28 can be fully embedded within body 40, being located therein when bushing 26 is formed. Magnet 28 may alternatively be one or more micromagnets. In another embodiment, magnet 28 can be replaced with a magnetically attractable material. In another embodiment, bushing 26 can be made of a magnetically attractable material.

In FIG. 8, another embodiment of arm 16 is depicted in a top view. Arm 16 in this preferred embodiment comprises a primary extension 50 and a levered arm 52. Primary extension 50 couples to lever arm 52 at a pivot 54. Therefore, in this preferred embodiment, levered arm 52 can be folded away when not in use. Locating lever arm 52 closer to pins 30 permits use of wider primary lenses 12 to increase corrected peripheral vision of the wearer.

FIG. 9 discloses another preferred embodiment of the present invention in which arm 16 employs a single pin 60 that protrudes through the holes in primary lens 12. Pin 60 is complete with barbs 62 to secure arm 16 to a bushing 70.

FIG. 10 illustrates bushing 70 of this preferred embodiment as designed to be employed with a single support, such as pin 60. In order to couple with pin 60, receptacle 78 protrudes from front surface 74 through holes in primary lenses 12 in a direction away from the face of the wearer. In this embodiment, receptacle 78 is preferably non-cylindrical in shape to prevent rotation of arm 16 relative to primary lens 12.

Referring to FIGS. 11, 15, and 16, another configuration in accordance with another preferred embodiment is illustrated. In this configuration, magnetic assembly 118 rests on the upper surface of bushing 26. Thus, both the magnetic coupling and mechanical supporting forces between magnetic assembly 118 and bushing 26 maintain the position of the auxiliary lens assembly 110 relative to primary lens assembly 10 to assist in preventing disengagement when vertical separating forces are applied.

In FIG. 12, magnet 28 is mounted in slot 48 substantially flush with the top surface of body 40, between front surface 42 and rear surface 46. Adhesives are commercially available and well known in the art for attaching magnets to eyewear. The same adhesives are applicable for use with magnets 28. As with the other embodiments, receptacles 44 protrude from front surface 42 of body 40 and allow bushing 26 to couple to pins 30 of arm 16.

As with other preferred embodiments, magnet 28 may alternatively be one or more micromagnets. In another embodiment of the present invention, magnet 28 can be replaced with a magnetically attractable material and magnets 128 can be located in magnetic assembly 118. In another embodiment, bushing 26 can be made of a magnetically attractable material.

As can best be seen in FIG. 13, bushing 26 can be configured such that magnet 28 faces upward for proximate coupling to magnetic assembly 118, as shown in FIG. 14. In this manner, the mechanical engagement of bushing 26 and magnetic assembly 118 prevents downward movement of auxiliary lens assembly 110 relative to primary lens assembly 10, thus preserving the alignment of primary lenses 12 to auxiliary lenses 112.

In addition to the illustrated embodiments of the present invention, there are a number of possible specific configurations of auxiliary extensions 116. In these varying configurations, auxiliary extensions 116 can magnetically couple magnetically attractable material that comprises arms 16 or to micromagnets (not shown) embedded in arms 16.

In another embodiment of the present invention, an auxiliary magnetic assembly 118 can be directly coupled to auxiliary bridge 114. Thus, when auxiliary lens assembly 110 engages primary lens assembly 10, auxiliary magnetic assembly 118 magnetically engages primary bridge 14.

In another embodiment, multiple micromagnets are fully embedded within body 40, or located in slot 48 on a surface of body 40 to increase the magnetic holding power of the assembly. Moreover, any combination of micromagnets used singularly, or in combination, can be employed in any embodiment described hereinabove.

It will be readily apparent to those skilled in the art that the general principles defined herein may be applied to other embodiments and applications without departing from the spirit and scope of the present invention.

Having thus described the present invention by reference to certain of its preferred embodiments, it is noted that the embodiments disclosed are illustrative rather than limiting in nature and that a wide range of variations, modifications, changes, and substitutions are contemplated in the foregoing disclosure and, in some instances, some features of the present invention may be employed without a corresponding use of the other features. Many such variations and modifications may be considered desirable by those skilled in the art based upon a review of the foregoing description of preferred embodiments. Accordingly, it is appropriate that the appended claims be construed broadly and in a manner consistent with the scope of the invention.

I claim:

1. A primary lens assembly, comprising:
a pair of primary lenses;
a bridge secured between the primary lenses;
at least one hole located on an outer periphery of each primary lens;
a pair of arms having a pin at one end;
a bushing attached through the holes of each primary lens for coupling to the a pin; and
a magnet embedded in the bushing.

2. The primary lens assembly of claim 1, wherein the magnet further comprises a magnet located in a slot substantially flush with an exterior surface of the bushing.

3. The primary lens assembly of claim 1, wherein the magnet further comprises a magnet fully embedded within the bushing.

4. The primary lens assembly of claim 1, wherein the magnet further comprises at least one micromagnet.

5. The primary lens assembly of claim 4, wherein the micromagnet further comprises a micromagnet formed of a Rare-Earth 2 Transition Element having a Maximum Energy Product of at least 210 kJ/m3.

6. The primary lens assembly of claim 4, wherein the micromagnet is formed of a material selected from the group consisting of Rare Earth Cobalt 5 alloys and Rare Earth Iron alloys.

7. The primary lens assembly of claim 4, wherein the micromagnet further comprises a micromagnet formed of an International Electrotechnical Commission (IEC) Code Reference R4-1 material.

8. The primary lens assembly of claim 4, wherein the micromagnet further comprises a micromagnet formed of an alloy comprising between 22 and 29 percent by weight samarium.

9. The primary lens assembly of claim 4, wherein the micromagnet is less than approximately 0.55 millimeters in height, less than approximately 0.55 millimeters in width, and being at least 1.2 millimeters in length.

10. The primary lens assembly of claim 4, wherein the micromagnet is approximately 0.45 millimeters in height and less than approximately 0.45 millimeters in width.

11. The primary lens assembly of claim 4, wherein the micromagnet is approximately 0.45 millimeters in height, approximately 0.45 millimeters in width, and approximately 2 millimeters in length.

12. The primary lens assembly of claim 4, wherein at least two micromagents are located in the slot.

13. A frameless eyewear system comprising:
a primary lens assembly comprising:
a pair of primary lenses secured in a fixed relationship to one another by a primary bridge;
a pair of arms, each arm secured through at least one hole in a primary lens;
a pair of bushings;
a primary magnetic assembly located within each bushing; and
wherein each bushing couples to an arm through the hole; and
an auxiliary lens assembly comprising:
a pair of auxiliary lenses secured in a fixed relationship to one another by an auxiliary bridge;
a pair of auxiliary extensions, each extension attached to an auxiliary lens;
an auxiliary magnetic assembly located at an end of each extension; and
wherein each auxiliary magnetic assembly is magnetically attachable to a primary magnetic assembly.
